(19) United States
(12) Patent Application Publication
(10) Pub. No.: US 2015/0198216 A1
(43) Pub. Date: Jul. 16, 2015

(54) ELECTROMAGNETIC ACTUATOR, AND ACTIVE VIBRATION DAMPER AND FLUID-FILLED ACTIVE VIBRATION DAMPING DEVICE USING THE SAME

(71) Applicant: SUMITOMO RIKO COMPANY LIMITED, Komaki-shi (JP)

(72) Inventors: Hironori KOYAMA, Kasugai-shi (JP); Masahiko NAGASAWA, Kasugai-shi (JP); Yuji HASHIMOTO, Iwakura-shi (JP)

(21) Appl. No.: 14/559,150

(22) Filed: Dec. 3, 2014

(30) Foreign Application Priority Data
Jan. 10, 2014 (JP) 2014-003709

(51) Int. Cl. F16F 15/00; F16F 13/08; H02K 41/035; F16F 13/26

(52) U.S. Cl. CPC F16F 15/005; F16F 13/26; F16F 13/08; H02K 41/035

(57) ABSTRACT

An electromagnetic actuator including a plate spring elastically coupling a stator and a mover. The plate spring includes an outer circumference attachment part and a center attachment part respectively attached to one and another of the stator and the mover. A plurality of spiral-shaped connection arm parts are provided at equal intervals in a circumferential direction radially between the outer circumference attachment part and the center attachment part. A direction recognizer is provided such that an orientation of the plate spring in the circumferential direction is recognizable from outside. The direction recognizer arranges the plate spring such that connection sites of the connection arm parts to the center attachment part and the outer circumference attachment part are circumferentially separated from at least one of input directions of a main load and a maximum load in a radial direction.

### INCORPORATED BY REFERENCE

The disclosure of Japanese Patent Application No. 2014-003709 filed on Jan. 10, 2014 including the specification, drawings and abstract is incorporated herein by reference in its entirety.

### BACKGROUND OF THE INVENTION

1. Field of the Invention

The present invention relates to an electromagnetic actuator by which a mover is driven in relation to a stator by energization to a coil, and to an active vibration damper and a fluid-filled active vibration damping device using the same.

2. Description of the Related Art

From the past, an electromagnetic actuator has been known as one type of vibration damping actuator used for actively controlling the vibration damping characteristics of a vibration damping device by applying active oscillation force to a member subject to vibration damping. With the electromagnetic actuator, the mover is attached so as to be displaceable relative to the stator, and by energization to a coil member arranged on one of either the stator or the mover, the mover is driven in relation to the stator.

However, as shown in Japanese Patent No. JP-B-4852030, with the electromagnetic actuator, the stator and the mover are linked to each other by a plate spring, and by elastic deformation of the plate spring in the thickness direction, displacement of the mover in relation to the stator is allowed, and the mover and stator are aligned to each other in the radial direction of the plate spring.

Also, with JP-B-4852030, so that sufficient displacement is allowed of the mover in the thickness direction of the plate spring, a plurality of lightening holes are formed on the plate spring, and the plate spring has a constitution with which an outer circumference attachment part attached to the stator and a center attachment part attached to the mover are integrally linked to each other by a plurality of connection arm parts. This connection arm part extends in the radial direction while being inclined in the circumferential direction, with one end being integrally connected to the outer circumference attachment part, and the other end being integrally connected to the center attachment part.

However, with the plate spring of JP-B-4852030, there are cases when stress is locally concentrated with the connection arm part in relation to radial direction input, so further improvement in durability was desired.

### SUMMARY OF THE INVENTION

The present invention was created with the circumstances described above as the background, and the problem it is to address is to provide an electromagnetic actuator of a novel structure for which it is possible to avoid plate spring damage due to input in the radial direction, and to advantageously ensure durability, as well as an active vibration damper and a fluid-filled active vibration damping device using the same.

Following, we will describe modes of the present invention created for addressing this kind of problem. The constitutional elements used with each mode noted hereafter can be used in as many combinations as are possible.

Specifically, a first mode of the present invention provides an electromagnetic actuator including: a stator; a mover attached displaceable in relation to the stator; a plurality of plate springs elastically coupling the stator and the mover; and a coil member attached to one of the stator and the mover, the coil member being energized to generate a magnetic field that exerts a force on the mover to drive the mover in relation to the stator, wherein the plate spring includes an outer circumference attachment part and a center attachment part respectively attached to one and another of the stator and the mover, a plurality of spiral-shaped connection arm parts are provided at equal intervals in a circumferential direction between the outer circumference attachment part and the center attachment part in a radial direction so as to extend in the radial direction while being inclined in the circumferential direction, and a direction recognizer is provided such that an orientation of the plate spring in the circumferential direction is recognizable from outside, and the direction recognizer arranges the plate spring such that connection sites of the connection arm parts to the center attachment part and the outer circumference attachment part are circumferentially separated from at least one of a main load input direction and a maximum load input direction in the radial direction.

With this kind of electromagnetic actuator constituted according to the first mode, the radial direction in which the load is input has both ends of the connection arm part, which are the connection sites to the outer circumference attachment part and the center attachment part, separated in the circumferential direction. Therefore, by preventing direct input of a load in the radial direction in relation to the end parts of the connection arm part at which stress concentrates easily, stress on the plurality of connection arm parts is dispersed, and improved durability is realized.

In fact, since the orientation of the plate spring in the circumferential direction is recognizable from outside using a direction recognizer, both end parts of each connection arm part can be easily arranged at separated positions in the circumferential direction in relation to the load input direction of the assumed radial direction.

When the radial direction in which the load is input most frequently (main load input direction) and the radial direction in which the greatest load is input are different from each other, for at least one of those load input directions, it is sufficient to have both end parts of the connection arm part positioned separated in the circumference direction, but more preferably, the orientation of the plate spring in the circumferential direction is set so that in relation to both of those load input directions, both end parts of the connection arm part are separated in the circumferential direction.

A second mode of the present invention provides the electromagnetic actuator according to the first mode, wherein the connection site of the connection arm part to the center attachment part and the connection site of the connection arm part to the outer circumference attachment part are arranged at mutually different positions in the circumferential direction.

With the second mode, by arranging both end parts of the connection arm part in positions skewed to each other in the circumferential direction, the stress that acts on both end parts of the connection arm part is more effectively reduced by elastic deformation of the middle part of the connection arm part or the like, and improved durability by dispersion of stress is advantageously realized.

A third mode of the present invention provides the electromagnetic actuator according to the first or second mode, wherein at least one of the mover and the stator is configured to attach to a vehicle, the main load input direction and the maximum load input direction in the radial direction of the plate spring both coincide with a front-back direction of the vehicle, and the direction recognizer arranges the plate spring such that the connection sites of the connection arm parts to the center attachment part and the outer circumference attachment part are set circumferentially separated from the front-back direction of the vehicle.

With the third mode, when using the electromagnetic actuator of the present invention for the vehicle for which both the main load input direction and the maximum load input direction in the radial direction coincide with the front-back direction, by setting the plate spring orientation and the mounting orientation of the electromagnetic actuator to the vehicle so as to have both end parts of each connection arm part be separated from the front-back direction of the vehicle, durability is improved. In particular, since it is possible to recognize the plate spring orientation from outside using the direction recognizer, it is possible to advantageously ensure durability of the plate spring by suitably setting the orientation of the electromagnetic actuator in relation to the vehicle.

A fourth mode of the present invention provides an active vibration damper including an actuator that is attached to a member subject to vibration damping and applies an oscillation force thereto, wherein the actuator is composed of an electromagnetic actuator according to any one of the first through -third modes, and the stator of the electromagnetic actuator is attached to the member subject to vibration damping, and the mover is elastically supported on the member subject to vibration damping via the plate spring.

With this kind of active vibration damper of a constitution according to the fourth mode, by using the electromagnetic actuator of the present invention, even if a radial direction load is input to the plate spring that links the mover and the stator, durability is advantageously ensured, and high reliability is realized.

A fifth mode of the present invention provides a fluid-filled active vibration damping device including: a first mounting member; a second mounting member; a main rubber elastic body elastically coupling the first and second mounting members; a pressure-receiving chamber a portion of whose wall is constituted by the main rubber elastic body and in which a non-compressible fluid is sealed, while another portion of the wall of the pressure-receiving chamber being constituted by an oscillation member; and an actuator that does oscillation driving of the oscillation member, wherein the actuator is composed of an electromagnetic actuator according to any one of the first through third modes, and the stator of the electromagnetic actuator is attached to the second mounting member, and the mover is attached to the oscillation member.

With this kind of fluid-filled active vibration damping device constituted according to the fifth mode, by using the electromagnetic actuator of the present invention as the actuator that does oscillation driving of the oscillation member, even if a radial direction load is input between the second mounting member and the oscillation member, durability of the plate spring is advantageously ensured, and high reliability is realized.

With the present invention, a direction recognizer is provided such that the orientation of the plate spring in the circumference direction is recognizable from outside, and the orientation of the plate spring is set by the direction recognizer such that the connection sites to the center attachment part and the outer circumference attachment part with the connection arm part of the plate spring are circumferentially separated from at least one of the main load input direction and the maximum load input direction in the radial direction. Therefore, direct action of the radial direction load on both end parts of the connection arm parts for which stress easily concentrates is avoided, and improved durability is realized by dispersion of stress.

### BRIEF DESCRIPTION OF THE DRAWINGS

The foregoing and/or other objects, features and advantages of the invention will become more apparent from the following description of a preferred embodiment with reference to the accompanying drawings in which like reference numerals designate like elements and wherein:

FIG. 1 is an elevational view in axial or vertical cross section of an active vibration damper according to a first embodiment of the present invention, which correlates to cross section taken along line 1-1 of FIG. 2;

FIG. 2 is a plan view of the active vibration damper shown in FIG. 1;

FIG. 3 is a plan view of a plate spring constituting the active vibration damper shown in FIG. 1; and

FIGS. 4A and 4B are views showing stress analysis results of the plate spring shown in FIG. 3, wherein FIG. 4A indicates Example for which the orientation of the plate spring is suitably set in relation to the load input direction, and FIG. 4B indicates Comparative Example for which the orientation of a plate spring is suitably set in relation to the load input direction.

### DETAILED DESCRIPTION OF PREFERRED EMBODIMENTS

Following we will describe an embodiment of the present invention while referring to the drawings.

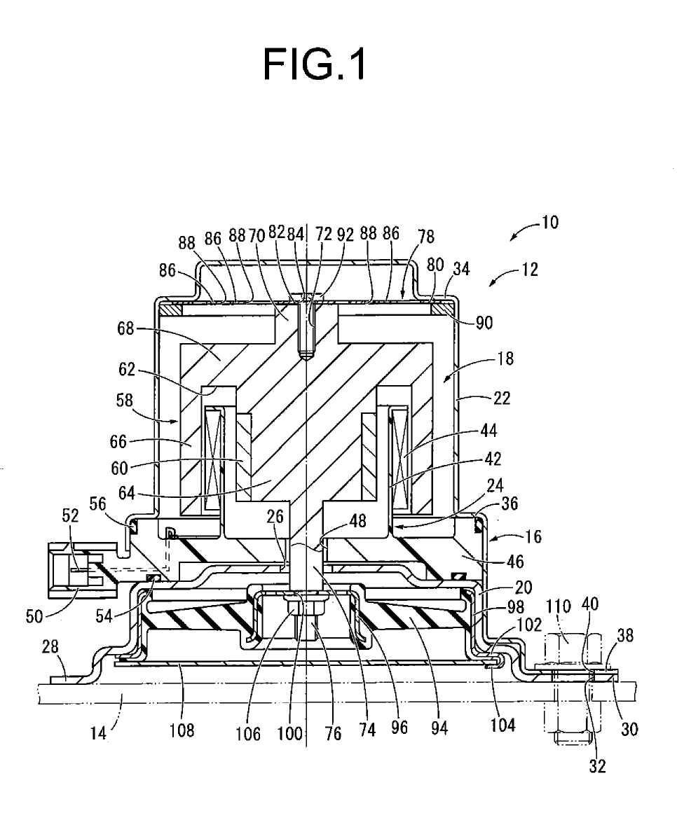

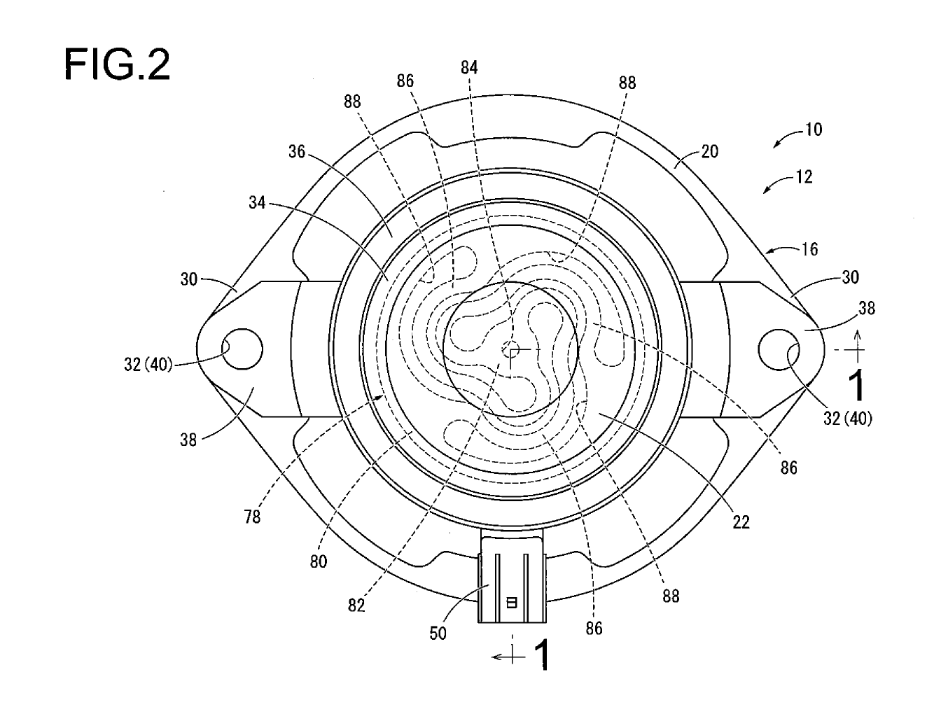

FIGS. 1 and 2 show an active vibration damper 10 as a first embodiment of the present invention. This active vibration damper 10 is equipped with an electromagnetic actuator 12 as an actuator, and by oscillation force of the electromagnetic actuator 12 being applied to a vehicle body 14 as a member subject to vibration damping, the vibration is decreased by offset. With the description below, the vertical direction means the vehicle vertical direction in a vehicle mounted state, and means the vertical direction in FIG. 1 which is the oscillation direction of the electromagnetic actuator 12, and the front-back direction means the vertical direction in FIG. 2 which coincides with the vehicle front-back direction in the vehicle mounted state.

In more detail, the electromagnetic actuator 12 is equipped with a stator 16 and a mover 18. The stator 16 has a constitution with a cover member 22 and a coil member 24 attached to a base member 20 fixed on the vehicle body 14.

The base member 20 has a roughly cylindrical shape with a bottom facing the reverse, and a lower through hole 26 that pierces vertically is formed on the center part of the upper base wall part. Furthermore, on a lower opening edge part of the base member 20, a flange part 28 that expands to the outer circumference side is formed across the entire circumference, and a pair of base attachment pieces 30, 30 that are larger and project to the outer circumference side are formed in the lateral radial direction. Bolt holes 32 are respectively formed piercing vertically on the pair of base attachment pieces 30, 30.

The cover member 22 has a roughly cylindrical shape with a bottom reverse facing the depth bottom, an upper base step part 34 is formed near the upper base wall part, an opening step part 36 is provided on the opening part, and the diameter becomes larger in steps facing downward which is the opening side. Also, the cover member 22 is equipped with a pair of cover attachment pieces 38, 38 laterally in the radial direction on the opening edge part that has a large diameter. The pair of cover attachment pieces 38, 38 have a plate shape extending out downward and for which the lower edge part is curved and extends laterally to the outside, and bolt holes 40 are formed piercing vertically on the lower edge part extending laterally outward.

Then, the cover member 22 has the pair of cover attachment pieces 38, 38 overlapping in the radial direction on the outer circumference surface of the base member 20, and overlapping vertically on the pair of base attachment pieces 30, 30, and aligned to each other. The bolt holes 32, 32 of the pair of base attachment pieces 30, 30 and the bolt holes 40, 40 of the pair of cover attachment pieces 38, 38 are aligned to each other.

Also, the coil member 24 is arranged between the base member 20 and the cover member 22. The coil member 24 has a constitution for which a coil 44 is wound onto a bobbin 42. The bobbin 42 is a hard member formed using a nonmagnetic material such as synthetic resin or the like, and overall has a roughly cylindrical shape with a bottom, and has coil 44 wound on it. Furthermore, a bottom wall part 46 of the bobbin 42 which has a thick wall is equipped with an upper through hole 48 piercing vertically at the radial direction center part, and projects in the radial direction outward across the entire circumference, and a power feed connector 50 is integrally formed on a part of the circumference. The power feed connector 50 projects facing backward from the bottom wall part 46 of the bobbin 42, and has an overturned roughly cylindrical shape with a bottom opening backward, and one end of a connector metal fitting 52 embedded in the bottom wall part 46 of the bobbin 42 projects to the inner circumference side of the power feed connector 50. The other end of the connector metal fitting 52 is connected to the coil 44.

Then, with the coil member 24, the outer circumference end part of the bottom wall part 46 is sandwiched vertically between the upper base wall part of the base member 20 and the opening step part 36 of the cover member 22, and is installed between the base member 20 and the cover member 22. Also, the power feed connector 50 of the coil member 24 projects facing backward from between the base member 20 and the cover member 22. Between the overlapping surfaces of the bottom wall part 46 of the bobbin 42 and the base member 20 and the cover member 22 are respectively sealed using ring shaped sealing rubbers 54 and 56, and penetration of foreign matter such as dust, water or the like is prevented.

The mover 18 is attached to the stator 16 constituted in this way. The mover 18 has a constitution with which a permanent magnet 60 is fixed to a yoke metal fitting 58. The yoke metal fitting 58 is formed with a ferromagnetic material such as iron or the like, and overall has a thick walled round block shape, and at the radial direction middle part, a circumferential groove 62 that opens at the bottom surface is formed extending in a circumferential direction with a ring shape. By doing this, on the yoke metal fitting 58, a center column part 64 with a roughly round column shape is formed on the inner circumference side of the circumferential groove 62, and a roughly cylindrical shaped outer circumference tube part 66 is formed on the outer circumference side of the circumferential groove 62, and at the top end, the center column part 64 and the outer circumference tube part 66 are integrally linked by a roughly disk shaped middle plate part 68.

Furthermore, at the radial direction center part of the yoke metal fitting 58, a coupling projection 70 projecting upward with a small diameter roughly round column shape is integrally formed, and a screw hole 72 opened at the top surface extending on the center axis is formed on the coupling projection 70. Furthermore, at the radial direction center part of the yoke metal fitting 58, a rod part 74 projecting downward is integrally formed, and on the rod part 74, a screw part 76 projecting downward is integrally formed.

The permanent magnet 60 has a roughly cylindrical shape, is magnetized in the radial direction, and has mutually different magnetic poles formed on the inner circumference surface and the outer circumference surface. Also, the permanent magnet 60 is externally fitted and fixed on the center column part 64 of the yoke metal fitting 58, and has mutually different magnetic poles formed on opposite sides of the circumferential groove 62 of the yoke metal fitting 58 so as to form a magnetic field inside the circumferential groove 62.

Also, with the mover 18, the yoke metal fitting 58 and the permanent magnet 60 are installed between the cover member 22 and the coil member 24, and it is housed in the stator 16. Also, the rod part 74 that extends out downward from the center column part 64 of the yoke metal fitting 58 is inserted through the upper through hole 48 of the bobbin 42 and the lower through hole 26 of the base member 20, and projects to the inner circumference of the base member 20.

Furthermore, the coil 44 of the coil member 24 is inserted into the circumferential groove 62 of the yoke metal fitting 58, and installed in the radial direction between the yoke metal fitting 58 outer circumference tube part 66 and the permanent magnet 60, and the coil 44 is positioned in the magnetic field formed by the permanent magnet 60 and the yoke metal fitting 58. The coil 44 and the tube part of the bobbin 42 on which the coil 44 is wound are arranged separated from both the permanent magnet 60 and the yoke metal fitting 58.

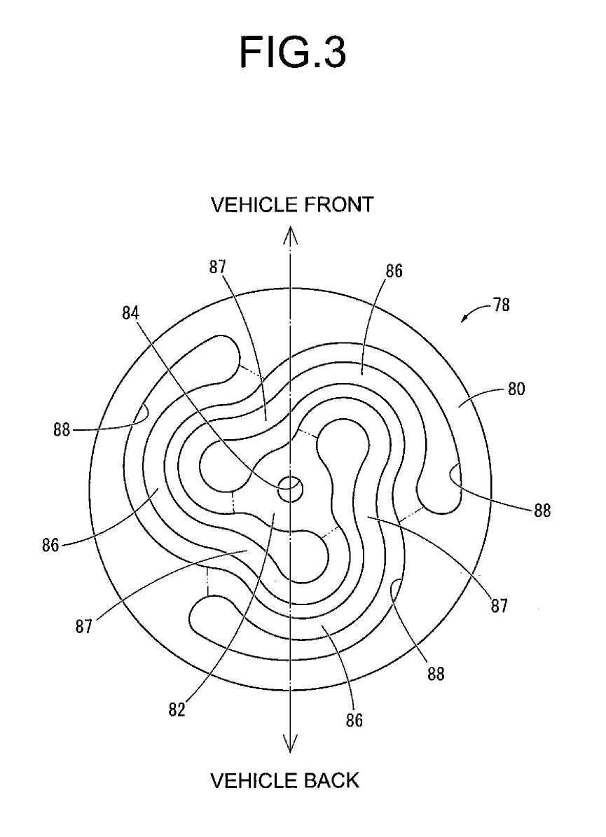

Also, the cover member 22 of the stator 16 and the yoke metal fitting 58 of the mover 18 are elastically coupled by a plate spring 78. As shown in FIGS. 1 and 3, the plate spring 78 is a thin walled roughly round plate shaped member formed of spring steel or the like, and its outer circumference end part is equipped with a roughly round ring shaped outer circumference attachment part 80, while its radial direction center is equipped with a roughly round plate shaped center attachment part 82. A screw hole 84 that pierces in the thickness direction is formed on the center attachment part 82.

Furthermore, three spiral-shaped connection arm parts 86, 86, 86 are formed radially between the outer circumference attachment part 80 and the center attachment part 82. The three connection arm parts 86, 86, 86 each extend in the radial direction while being inclined in the circumferential direction, they have roughly the same shape to each other, and are arranged at equal intervals on the circumference. More specifically, the connection arm part 86 has a middle curved part 87 curved so as to be concave opening towards the outer circumference and extending in roughly the circumferential direction, and both side parts of the middle curved part 87 curve so as to be convex facing the outer circumference, and extend in roughly the circumferential direction. In this way, the incline angles of the connection arm parts 86 differ in the length direction, and by the connection arm parts 86 being wavy, an increase in the effective free length accompanied by dispersion of the stress and distortion is achieved.

Also, the three connection arm parts 86, 86, 86 have one end connected to the outer circumference attachment part 80, and the other end connected to the center attachment part 82, and the outer circumference attachment part 80 and the center attachment part 82 are integrally linked to each other by the three connection arm parts 86, 86, 86. Also, the respective ends of the connection arm part 86 linked to the outer circumference attachment part 80 and the center attachment part 82 are arranged at mutually different positions in the circumferential direction, and the direction of extension from the outer circumference attachment part 80 and the direction of extension from the center attachment part 82 are mutually different. Skew of both ends of the connection arm part 86 is preferably ⅙ of a circumference or greater in the circumferential direction, and more preferably ¼ circumference or greater and ⅘ of a circumference or less.

Moreover, between the three connection arm parts 86, 86, 86, slits 88 are respectively formed. The slits 88 pierce through the plate spring 78 in the thickness direction, and extend in the radial direction while being inclined in the circumferential direction.

Also, as shown in FIG. 1, the outer circumference attachment part 80 of the plate spring 78 is sandwiched vertically between the upper base step part 34 of the cover member 22 and a ring member 90 fit into the cover member 22, and the center attachment part 82 of the plate spring 78 is overlapped on the coupling projection 70 of the yoke metal fitting 58, and is fixed to the yoke metal fitting 58 by a screw 92 screwed into screw hole 72 of the coupling projection 70. With these, the outer circumference part of the plate spring 78 is attached to the stator 16, and the center part of the plate spring 78 is attached to the mover 18, and the stator 16 and the mover 18 are mutually linked by the plate spring 78. As a result, the stator 16 and the mover 18 are relatively positioned in the radial direction by the plate spring 78, and by the elastic deformation in the thickness direction of the plate spring 78, is displaceable vertically in the axis direction relative to the stator 16.

With the electromagnetic actuator 12 constituted as described above, the power feed connector 50 is connected to an external power supply (not illustrated), and by power being fed to the coil 44, current flows in the magnetic field formed by the permanent magnet 60 and the yoke metal fitting 58, and oscillation drive force is applied based on the electromagnetic force between the stator 16 and the mover 18. Also, by the generated oscillation drive force, the mover 18 is driven and displaced vertically in relation to the stator 16.

Also, the mover 18 and the stator 16 of the electromagnetic actuator 12 are elastically coupled by a support rubber elastic body 94. The support rubber elastic body 94 is a rubber elastic body having a roughly round ring plate shape, with an inner circumference fixing member 96 vulcanized and adhered to the inner circumference edge part, and an outer circumference fixing member 98 vulcanized and adhered to the outer circumference end part. The inner circumference fixing member 96 is a hard member having a roughly round cylinder shape with a bottom facing the reverse with a small diameter, and a screw hole 100 is formed in the radial direction center part of the upper base wall part. The outer circumference fixing member 98 is a hard member having a large diameter roughly round cylinder shape, with a ring shaped abutting piece 102 projecting to the outer circumference integrally formed on the lower edge, and a crimping piece 104 extending out further downward from the ring shaped abutting piece 102 integrally formed in part on the circumference. Also, the inner circumference end part of the support rubber elastic body 94 is vulcanized and adhered to the entire surface of the circumference wall part of the inner circumference fixing member 96, and the outer circumference end part of the support rubber elastic body 94 is vulcanized and adhered to the inner circumference surface of the outer circumference fixing member 98. The support rubber elastic body 94 of this embodiment is formed as an integrally vulcanization molded component equipped with the inner circumference fixing member 96 and the outer circumference fixing member 98.

Also, the screw part 76 of the yoke metal fitting 58 is inserted through the screw hole 100 of the inner circumference fixing member 96, and by screwing it in a nut 106 arranged below the screw hole 100, the inner circumference end part of the support rubber elastic body 94 is fixed to the mover 18. Furthermore, by the outer circumference fixing member 98 being fit to the circumference wall part of the base member 20, the outer circumference end part of the support rubber elastic body 94 is attached to the stator 16. By doing this, the stator 16 and the mover 18 are elastically coupled to each other by the plate spring 78 at the top part, and are elastically coupled to each other by the support rubber elastic body 94 at the bottom part.

Also, a lid member 108 is installed beneath the support rubber elastic body 94. The lid member 108 has a thin walled, large diameter roughly round plate shape, and by having the outer circumference end part crimped by the crimping piece 104 at a plurality of locations on the circumference, it is fixed to the outer circumference fixing member 98. The outer circumference end part of the support rubber elastic body 94 adhered to the lower surface of the ring shaped abutting piece 102 is interposed between the outer circumference fixing member 98 ring shaped abutting piece 102 and the lid member 108, and between the overlapping surfaces of the ring shaped abutting piece 102 and the lid member 108 is sealed, so penetration of foreign matter is prevented.

With the active vibration damper 10 with this kind of constitution, the stator 16 is directly fixed to the vehicle body 14, and the mover 18 is indirectly elastically supported on the vehicle body 14 via the plate spring 78 and the support rubber elastic body 94, thus being mounted on the vehicle. Specifically, as shown in FIG. 1, attachment bolts 110 are inserted through each bolt hole 32 and 40 of the base member 20 and the cover member 22 constituting the stator 16, and by the attachment bolts 110 being screwed into the vehicle body 14 side, the stator 16 is fixed to the vehicle body 14. Meanwhile, the mover 18 is elastically coupled to the stator 16 by the plate spring 78 and the support rubber elastic body 94, so it is supported on the vehicle body 14 via the stator 16.

Also, the stator 16 is able to specify the orientation of the circumferential direction from outside using the projection direction of the base attachment pieces 30, 30 with the base member 20 and the cover attachment pieces 38, 38 with the cover member 22, and the projection direction of the power feed connector 50 with the coil member 24. By doing this, the orientation of the stator 16 to the vehicle body 14 with the circumferential direction can be easily confirmed from outside by a visual check or the like, and the stator 16 can be attached in a suitable orientation to the vehicle body 14.

Furthermore, with the plate spring 78, the orientation in the circumferential direction in relation to the stator 16 is set in advance to a specific orientation, and relative rotation of the circumferential direction in relation to the stator 16 is prevented. By doing this, even if the plate spring 78 covered by the cover member 22 is not viewed directly, it is possible to confirm from the outside the orientation of the plate spring 78 using the orientation of the stator 16. Therefore, as shown in FIG. 2, by attaching the stator 16 to the vehicle body 14 in a suitable orientation, it is possible to suitably set the orientation of the plate spring 78 in the circumferential direction in relation to the vehicle body 14. As is clear from the above, with this embodiment, the direction recognizer is constituted by fixing the outer circumference attachment part 80 of the plate spring 78 being fixed between the upper base step part 34 and the ring member 90, and by the projection direction of the attachment pieces 30 and 38 as well as the power feed connector 50 with the stator 16.

Here, as is also shown in FIG. 3, orientation of the plate spring 78 of this embodiment to the vehicle body 14 in the circumference direction is set using the direction recognizer so that both ends of each of the three connection arm parts 86, 86, 86 which are the connection sites to the outer circumference attachment part 80 and the center attachment part 82 are circumferentially separated from the front-back direction of the vehicle. To make this easier to understand, both ends of the connection arm part 86 are shown hypothetically in FIG. 3 using chain double-dashed lines.

Specifically, with this embodiment, with the load acting in the radial direction of the plate spring 78, the load of the front-back direction due to vehicle acceleration, deceleration or the like is input most frequently and becomes the largest. In light of that, in relation to the vehicle front-back direction which coincides with the main load input direction and also the maximum load input direction, the orientation of the plate spring 78 is set so that both ends of the connection arm part 86 are separated in the circumferential direction. With this embodiment, the plate spring 78 is aligned in the circumferential direction in relation to the stator 16, so by the stator 16 being attached to the vehicle body 14, the plate spring 78 is arranged so as to be in a designated orientation in the circumferential direction.

With the plate spring 78, stress concentrates easily at both ends of the connection arm part 86 and at the connection sites of the outer circumference attachment part 80 and the center attachment part 82 in relation to radial direction load input. In light of that, by setting the orientation in the circumferential direction of the plate spring 78 as described above, frequent input of large loads in the radial direction is avoided at the connection sites, and durability is improved by dispersing the stress.

More preferably, the orientation in the circumferential direction of the plate spring 78 is set so that the area of 1/10 of the full length from both ends of the connection arm part 86 is circumferentially separated from the vehicle front-back direction. By doing this, the mutual load between the plurality of connection arm parts 86, 86, 86 is dispersed, and dispersion of the stress and distortion of each connection arm part 86 is realized even more advantageously by the deformation and displacement of the middle part of the connection arm part 86.

Also, with the plate spring 78 of this embodiment, both ends of each single connection arm part 86 are arranged at mutually different positions in the circumferential direction. Therefore, when a load is input in the radial direction, due to elastic deformation of the middle part of the connection arm part 86, the stress and thus distortion transmitted to both end parts of the connection arm part 86 is reduced by dispersion or the like to the middle part, and the stress that acts on both end parts of the connection arm part 86 is more advantageously reduced, so durability is further improved.

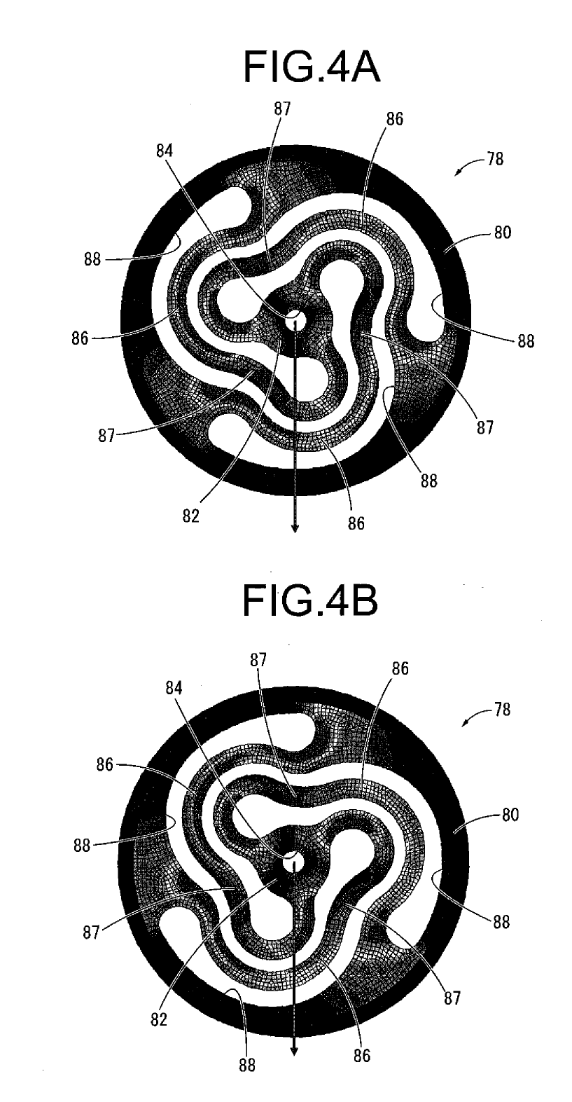

This kind of dispersion of stress can also be confirmed by stress distribution simulation. Specifically, shown in FIG. 4A is the stress distribution of the embodiment for which the orientation of the plate spring 78 in the circumferential direction is set so that both ends of each connection arm part 86 are circumferentially separated from the load input direction, and shown in FIG. 4B is the stress distribution of Comparative Example for which the orientation of the plate spring 78 in the circumferential direction is set so that both ends of each connection arm part 86 are positioned in the load input direction. With the results of this simulation, it was confirmed that with the embodiment of the present invention (FIG. 4A), compared to Comparative Example (FIG. 4B), the maximum stress of the connection arm part 86 is reduced, and durability is improved by dispersion of the stress.

Also, by the durability of the plate spring 78 improving, excellent reliability is realized with the electromagnetic actuator 12 and the active vibration damper 10 using the same.

Above, we gave a detailed description of an embodiment of the present invention, but the present invention is not limited by that specific description. For example, the specific number and shape of the connection arm part with the plate spring are not to be interpreted as being limited by the embodiment noted above.

It is also possible to use a plurality of plate springs overlapped. Furthermore, the plurality of plate springs can be arranged at positions separated vertically, and the mover and the stator can be linked to each other at both sides top and bottom by those plate springs. When using a plurality of the plate springs, preferably, those plate springs have mutually the same shape, and are arranged in the same orientation in the circumference direction.

Also, for example, it is possible to form notches or holes on the plate spring and also form projections on the stator, and by the projections locking with the plate spring notches or holes in the circumferential direction, the plate spring can be aligned to the stator in the circumferential direction.

It is also possible to link the mover and stator by the plate spring having the outer circumference attachment part attached to the mover, and the center attachment part attached to the stator.

Also, with the embodiment noted above, the main load input direction of frequent input and the maximum load input direction had the same radial direction as each other, but when they have different radial directions to each other, it is also possible to set the orientation of the plate spring in the circumferential direction so that both ends of the connection arm part are circumferentially separated from one of those load input directions according to the input size or frequency, the required durability performance and the like.

Also, when the electromagnetic actuator, active vibration damping device, fluid-filled active vibration damping device or the like has a rotational symmetrical form, and it is difficult to identify the orientation of the circumference direction by the external form, it is also possible to constitute the direction recognizer by providing irregularities, or markings by printing or the like. It is also possible to constitute the direction recognizer by making it possible to visually recognize the plate spring itself from outside.

With this embodiment, we showed an example of the active vibration damper 10 equipped with the electromagnetic actuator 12 of the present invention, but for example, it is also possible to use the electromagnetic actuator of the present invention as the actuator of a fluid-filled active vibration damping device such as that shown in Japanese Patent No. JP-B-4852030. Specifically, the fluid-filled active vibration damping device has a constitution such that a first mounting member and a second mounting member are elastically coupled by a main rubber elastic body, and a pressure-receiving chamber is formed a portion of whose wall is constituted by the main rubber elastic body, and non-compressible fluid or liquid is sealed in that pressure-receiving chamber. Furthermore, another portion of the wall of the pressure-receiving chamber is constituted by an oscillation member, and using the electromagnetic actuator of the present invention as the actuator that does oscillation driving of the oscillation member, the stator of the electromagnetic actuator is attached to the second mounting member, and the mover is attached to the oscillation member. Also, by the oscillation member being driven by the electromagnetic actuator, active oscillation force is applied to the pressure-receiving chamber, and it is possible to offset and reduce the input vibration.

Also, with this embodiment, an example was shown with the vehicle body 14 as the member subject to vibration damping to which the active vibration damper 10 is attached, but the member subject to vibration damping is not particularly limited.

What is claimed is:

1. An electromagnetic actuator comprising:
a stator;
a mover attached displaceable in relation to the stator;
a plate spring elastically coupling the stator and the mover; and
a coil member attached to one of the stator and the mover, the coil member being energized to generate a magnetic field that exerts a force on the mover to drive the mover in relation to the stator, wherein
the plate spring includes an outer circumference attachment part and a center attachment part respectively attached to one and another of the stator and the mover,
a plurality of spiral-shaped connection arm parts are provided at equal intervals in a circumferential direction between the outer circumference attachment part and the center attachment part in a radial direction so as to extend in the radial direction while being inclined in the circumferential direction, and
a direction recognizer is provided such that an orientation of the plate spring in the circumferential direction is recognizable from outside, and the direction recognizer arranges the plate spring such that connection sites of the connection arm parts to the center attachment part and the outer circumference attachment part are circumferentially separated from at least one of a main load input direction and a maximum load input direction in the radial direction.

2. The electromagnetic actuator according to claim 1, wherein the connection site of the connection arm part to the center attachment part and the connection site of the connection arm part to the outer circumference attachment part are arranged at mutually different positions in the circumferential direction.

3. The electromagnetic actuator according to claim 1, wherein
at least one of the mover and the stator is configured to attach to a vehicle,
the main load input direction and the maximum load input direction in the radial direction of the plate spring both coincide with a front-back direction of the vehicle, and
the direction recognizer arranges the plate spring such that the connection sites of the connection arm parts to the center attachment part and the outer circumference attachment part are set circumferentially separated from the front-back direction of the vehicle.

4. An active vibration damper comprising an actuator that is attached to a member subject to vibration damping and applies an oscillation force thereto, wherein
the actuator is composed of an electromagnetic actuator that includes: a stator; a mover attached displaceable in relation to the stator; a plate spring elastically coupling the stator and the mover; and a coil member attached to one of the stator and the mover, the coil member being energized to generate a magnetic field that exerts a force on the mover to drive the mover in relation to the stator, wherein the plate spring includes an outer circumference attachment part and a center attachment part respectively attached to one and another of the stator and the mover, a plurality of spiral-shaped connection arm parts are provided at equal intervals in a circumferential direction between the outer circumference attachment part and the center attachment part in a radial direction so as to extend in the radial direction while being inclined in the circumferential direction, and a direction recognizer is provided such that an orientation of the plate spring in the circumferential direction is recognizable from outside, and the direction recognizer arranges the plate spring such that connection sites of the connection arm parts to the center attachment part and the outer circumference attachment part are circumferentially separated from at least one of a main load input direction and a maximum load input direction in the radial direction, and
the stator of the electromagnetic actuator is attached to the member subject to vibration damping, and the mover is elastically supported on the member subject to vibration damping via the plate spring.

5. A fluid-filled active vibration damping device comprising:
a first mounting member;
a second mounting member;
a main rubber elastic body elastically coupling the first and second mounting members;
a pressure-receiving chamber a portion of whose wall is constituted by the main rubber elastic body and in which a non-compressible fluid is sealed, while another portion of the wall of the pressure-receiving chamber being constituted by an oscillation member; and
an actuator that does oscillation driving of the oscillation member, wherein
the actuator is composed of an electromagnetic actuator that includes: a stator; a mover attached displaceable in relation to the stator; a plate spring elastically coupling the stator and the mover; and a coil member attached to one of the stator and the mover, the coil member being energized to generate a magnetic field that exerts a force on the mover to drive the mover in relation to the stator, wherein the plate spring includes an outer circumference attachment part and a center attachment part respectively attached to one and another of the stator and the mover, a plurality of spiral-shaped connection arm parts are provided at equal intervals in a circumferential direction between the outer circumference attachment part and the center attachment part in a radial direction so as to extend in the radial direction while being inclined in the circumferential direction, and a direction recognizer is provided such that an orientation of the plate spring in the circumferential direction is recognizable from outside, and the direction recognizer arranges the plate spring such that connection sites of the connection arm parts to the center attachment part and the outer circumference attachment part are circumferentially separated from at least one of a main load input direction and a maximum load input direction in the radial direction, and
the stator of the electromagnetic actuator is attached to the second mounting member, and the mover is attached to the oscillation member.
